(19) United States
(12) Patent Application Publication
(10) Pub. No.: US 2019/0389053 A1
(43) Pub. Date: Dec. 26, 2019

(54) ROBOT

(71) Applicant: KAWASAKI JUKOGYO KABUSHIKI KAISHA, Kobe-shi, Hyogo (JP)

(72) Inventor: Yukio IWASAKI, Kobe-shi (JP)

(73) Assignee: KAWASAKI JUKOGYO KABUSHIKI KAISHA, Kobe-shi, Hyogo (JP)

(21) Appl. No.: 16/491,646

(22) PCT Filed: Mar. 6, 2018
(86) PCT No.: PCT/JP2018/008477

§ 371 Date: Sep. 6, 2019

(30) Foreign Application Priority Data
Mar. 6, 2017 (JP) 2017-041926

(51) Int. Cl. B25J 9/06; B25J 5/00; B25J 9/00

(52) U.S. Cl. CPC B25J 9/06; B25J 9/0096; B25J 5/007

(57) ABSTRACT

A robot includes: a main body portion; a first robot arm and a second robot arm each being located at the main body portion and including a plurality of joint shafts, the first and second robot arms sharing a first joint shaft; and a worktable being located at the main body portion and including a work surface where the robot performs work.

### TECHNICAL FIELD

The present invention relates to a robot.

### BACKGROUND ART

In recent years, proposed is that for the purpose of improving productivity, a robot is introduced to a production line and works in the line that is the same as the line where a human works. For example, PTL 1 discloses a double arm robot including a worktable where predetermined work is performed. PTL 2 discloses a robot including a plurality of robot arms capable of performing a cooperative operation. In this robot, each robot arm is suspended and supported by a head, and a worktable on which a workpiece handled by the robot arm is arranged is integrated with the head through a support post.

### CITATION LIST

### Patent Literature

PTL 1: Japanese Laid-Open Patent Application Publication No. 2013-252601

PTL 2: Japanese Laid-Open Patent Application Publication No. 7-308877

### SUMMARY OF INVENTION

### Technical Problem

However, according to the robot of PTL 1, a main body portion of the robot and the worktable are configured separately. Therefore, when relocating the robot, a positional relation between the worktable and the robot changes incorrectly. Thus, relocating work becomes complex.

The robot of PTL 2 is configured to perform work of picking up workpieces loaded in bulk. Therefore, the workpieces handled by the robot arm are just placed on the worktable (pallet). On this account, the worktable does not include a work surface where predetermined work (assembly work, for example) is performed. Further, the robot arm is suspended by the head. Therefore, if the number of robot arms increases, the robot increases in size. As a result, when the weight of the robot increases, the relocating work becomes difficult.

The present invention was made to solve the above problems, and an object of the present invention is to provide a robot which performs predetermined work and is relocated easily.

### Solution to Problem

To achieve the above object, a robot according to one aspect of the present invention includes: a main body portion; a first robot arm and a second robot arm each provided at the main body portion and including a plurality of joint shafts, the first and second robot arms sharing a first joint shaft; and a worktable provided at the main body portion and including a work surface where the robot performs work.

According to the above configuration, since the worktable including the work surface is provided at the main body portion of the double arm robot in which the first joint shaft is shared, the worktable does not have to be newly prepared for each work, and this leads to a cost reduction. Further, even when relocating the robot, a positional relation between the worktable and the robot does not change incorrectly. Thus, the robot can be relocated. Further, the worktable on which a jig and the like are mounted does not have to be fixed by anchors.

The robot may further include a moving unit provided at a lower side of the main body portion and configured to move the main body portion.

According to the above configuration, since the moving unit is included at the lower side of the main body portion, relocating work of the robot is facilitated.

The worktable may be configured to be attachable to and detachable from the main body portion.

According to the above configuration, by detaching the worktable, a lateral width of the robot becomes compact. Therefore, the relocating work is facilitated.

The first and second robot arms may be horizontal articulated robot arms.

### Advantageous Effects of Invention

The present invention is configured as described above and has an effect of being able to provide a robot which performs predetermined work and is relocated easily.

### BRIEF DESCRIPTION OF DRAWINGS

FIG. 1 is a perspective view schematically showing the entire configuration of a robot according to one embodiment of the present invention.

FIG. 2 is a front view showing the configuration of the robot of FIG. 1.

FIG. 3 is a plan view showing one example of operations of the robot of FIG. 1.

### DESCRIPTION OF EMBODIMENTS

Hereinafter, preferred embodiments will be described with reference to the drawings. In the following description and the drawings, the same reference signs are used for the same or corresponding components, and a repetition of the same explanation is avoided. For ease of understanding, components are schematically shown in the drawings. A direction in which a pair of arms are spread is referred to as a left-right direction. A direction parallel to a center axis of a base shaft is referred to as an upper-lower direction. A direction perpendicular to the left-right direction and the upper-lower direction is referred to as a front-rear direction.

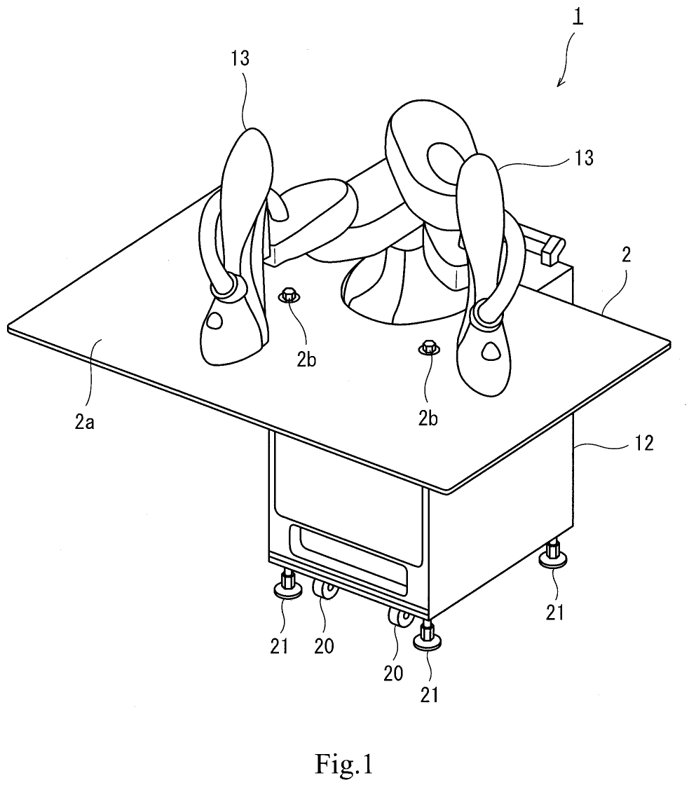

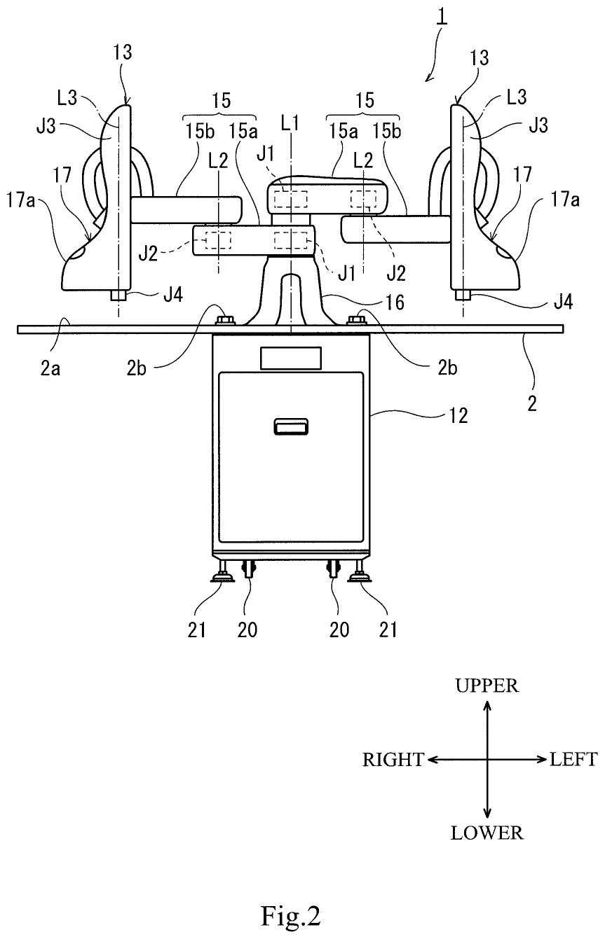

FIG. 1 is a perspective view schematically showing the entire configuration of a robot according to Embodiment 1 of the present invention. FIG. 2 is a front view showing the configuration of the robot of FIG. 1.

A robot 1 includes: a base (main body portion) 12; a pair of robot arms (hereinafter may be simply referred to as “arms”) 13 supported by the base 12; a worktable 2 where the robot 1 performs work; and a controller (not shown) accommodated in the base 12.

The base 12 includes a casing having a substantially rectangular solid shape, and various units, such as the controller (not shown), of the robot 1 are accommodated in the casing. A plurality of casters (moving unit) 20 and a plurality of adjusters 21 are provided on a lower surface of the base 12. The robot 1 is moved to a predetermined position by the plurality of casters 20. At the predetermined position, the robot 1 is restricted from moving and is placed by the plurality of adjusters 21.

Each of the arms 13 includes a plurality of joint shafts and is configured to be movable relative to the base 12. The arm 13 includes an arm portion 15, a wrist portion 17, and an end effector (not shown). In the present embodiment, the robot arm is a horizontal articulated robot arm. It should be noted that the right arm 13 and the left arm 13 may be substantially the same in structure as each other. Further, the right arm 13 and the left arm 13 can operate independently and can also operate in cooperation with each other.

In the present embodiment, the arm portion 15 is constituted by a first link 15a and a second link 15b. The first link 15a is coupled to a base shaft 16 by a rotary joint J1, the base shaft 16 being fixed to an upper surface of the base 12. The first link 15a is rotatable about a rotation axis L1 extending through a center axis of the base shaft 16. The second link 15b is coupled to a tip end of the first link 15a by a rotary joint J2. The second link 15b is rotatable about a rotation axis L2 defined at the tip end of the first link 15a.

The wrist portion 17 is constituted by an up/down portion 17a and a rotary portion 17b. The up/down portion 17a is coupled to a tip end of the second link 15b by a linear motion joint J3 and can move up and down relative to the second link 15b. The rotary portion 17b is coupled to a lower end of the up/down portion 17a by a rotary joint J4. The rotary portion 17b is rotatable about a rotation axis L3 defined at the lower end of the up/down portion 17a. End effectors (not shown) configured to perform predetermined work are coupled to the respective rotary portions 17b of the wrist portions 17.

Each arm 13 configured as above includes the joints J1 to J4. Servomotors for driving (not shown), encoders (not shown) configured to detect rotation angles of the servomotors, and the like are provided at the arm 13 so as to correspond to the respective joints J1 to J4. The robot 1 of the present embodiment is a coaxial double-arm robot. The two arms 13 share the first joint J1. The rotation axes L1 of the first links 15a of the two arms 13 are located on the same straight line. The first link 15a of one of the arm 13 and the first link 15a of the other arm 13 are arranged with a height difference therebetween in an upper-lower direction.

The worktable 2 includes a work surface 2a where the robot performs work. The work surface 2a is rectangular in a plan view. The worktable 2 is detachably provided on the upper surface of the base 12 by fastening members 2b, such as screws.

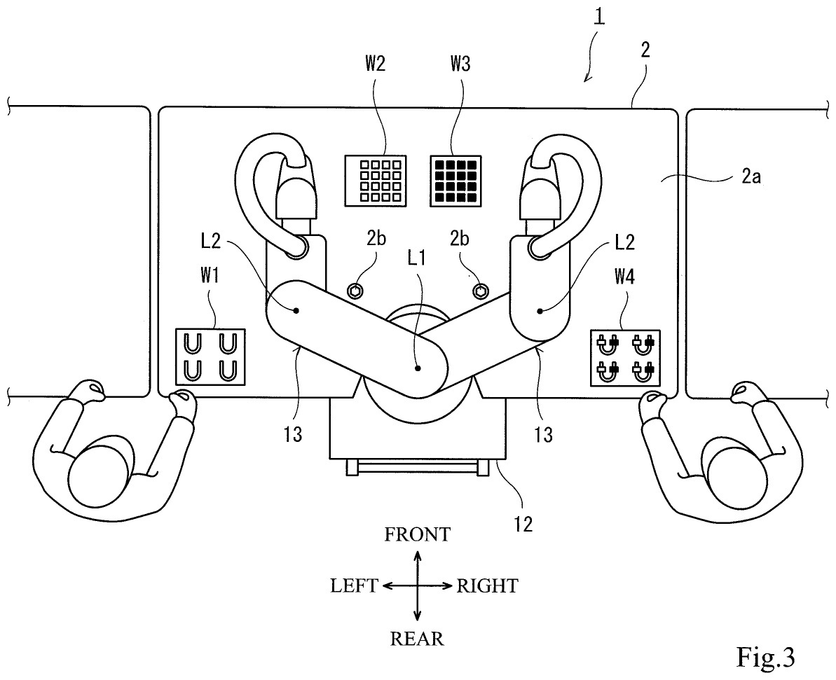

Next, one example of operations of the robot 1 configured to perform predetermined work at the worktable 2 will be described with reference to FIG. 3. As shown in FIG. 3, for example, the robot 1 is configured to be introduced to a production line and perform work in the line that is the same as the line where a worker works. The robot 1 includes a reference coordinate system (hereinafter referred to as a “base coordinate system”). The origin of the coordinate system is, for example, an intersection point between the work surface 2a of the worktable 2 and the rotation axis L1 of the first joint J1 (see FIG. 2) of each of the left and right arms 13. The rotation axis L1 of the first joint J1 is a z-axis. An arbitrary axis perpendicular to the z-axis is an x-axis, and an axis perpendicular to the z-axis and the x-axis is a y-axis. An operating region of the left and right arms 13 of the robot 1 is set based on the base coordinate system. In the present embodiment, the operating region is set to be rectangular in a plan view. The operating region covers the work surface 2a of the worktable 2 arranged in front of the robot 1. Four types of workpieces (W1, W2, W3, and W4) are arranged on the worktable 2. A worker located on the left side of the robot 1 supplies a material member W1 to the robot 1. The robot 1 attaches a first part W2 and a second part W3 to the supplied material member W1 to complete a processed product W4. A worker located on the right side of the robot 1 performs a next work step with respect to the completed processed product W4.

Therefore, according to the present embodiment, since the worktable 2 including the work surface 2a is provided at the base 12 of the robot 1, the worktable does not have to be newly prepared for each work, and this leads to a cost reduction. Further, even when relocating the robot, a positional relation between the worktable 2 and the robot 1 do not change incorrectly. Thus, relocating work of the robot 1 is facilitated. Further, the worktable on which a jig and the like are mounted does not have to be fixed by anchors.

Since the robot 1 of the present embodiment is the coaxial double-arm robot, an installation space is small, and the robot 1 can perform work similar to fine manual work performed by humans.

Since the robot 1 includes the casters 20 at a lower side of the base 12, the work of relocating the robot 1 is easy.

The worktable 2 is detachably attached to the base 12. Therefore, by detaching the worktable 2, the dimension (widths in the front-rear direction and the left-right direction) of the robot 1 becomes compact. Thus, the relocating work is facilitated.

### OTHER EMBODIMENTS

The robot 1 of the above embodiment includes the horizontal articulated robot arms 13. However, the robot 1 may be, for example, a cartesian coordinate robot as long as the robot 1 is a double arm robot in which the first joint J1 is shared.

From the foregoing explanation, many modifications and other embodiments of the present invention are obvious to one skilled in the art. Therefore, the foregoing explanation should be interpreted only as an example and is provided for the purpose of teaching the best mode for carrying out the present invention to one skilled in the art. The structures and/or functional details may be substantially modified within the scope of the present invention.

### INDUSTRIAL APPLICABILITY

The present invention is useful for working robots that perform predetermined work.

### REFERENCE SIGNS LIST

1 robot
2 worktable
2a work surface
2b fastening member
12 base (main body portion)
13 robot arm
15 arm portion
17 wrist portion

1. A robot comprising:
a main body portion;
a first robot arm and a second robot arm each provided at the main body portion and including a plurality of joint shafts, the first and second robot arms sharing a first joint shaft; and
a worktable provided at the main body portion and including a work surface where the robot performs work.

2. The robot according to claim 1, further comprising a moving unit provided at a lower side of the main body portion and configured to move the main body portion.

3. The robot according to claim 1, wherein the worktable is configured to be attachable to and detachable from the main body portion.

4. The robot according to claim 1, wherein the first and second robot arms are horizontal articulated robot arms.

5. The robot according to claim 2, wherein the worktable is configured to be attachable to and detachable from the main body portion.

6. The robot according to claim 2, wherein the first and second robot arms are horizontal articulated robot arms.

7. The robot according to claim 3, wherein the first and second robot arms are horizontal articulated robot arms.
